(19) United States
(12) Patent Application Publication
(10) Pub. No.: US 2021/0027581 A1
(43) Pub. Date: Jan. 28, 2021

(54) ELECTRONIC GAMING HAVING GAME STATE LOCK AND RESULT PREVIEW

(71) Applicant: GG SOFTWARE AS, Sandefjord (NO)

(72) Inventors: Brett David Calapp, Austin, TX (US); William Edward Griffiths, Tisbury (GB); Kasey Shannon Thompson, Phoenix, AZ (US)

(21) Appl. No.: 16/518,604

(22) Filed: Jul. 22, 2019

(51) Int. Cl. G07F 17/32; G07F 17/34

(52) U.S. Cl. CPC G07F 17/3265; G07F 17/34; G07F 17/3213

(57) ABSTRACT

Electronic gaming has a game state lock and preview of the game's result. A player's game state from a first played game is locked by the system operator. The game state and result of a game is displayed to the player once the game has completed its gameplay mechanic as a preview for deciding whether or not to exchange a credit amount for the result. The result displayed is from a ledger of results maintained by the system operator and determined by the system operator. Should a player decide to perform this exchange, the game is over. The next game is then available to be played on the game display having no relation to the previous game or result.

### BACKGROUND

The disclosure is related to amusement and entertainment electronic gaming. More particularly, this disclosure is directed to providing multiple games, the use of locking a game state, and a preview of the game's result displayed for players of an amusement or entertainment electronic game once the game has completed its gameplay mechanic but prior to game's end.

Amusement and entertainment type electronic games are popular. To enhance the amusement and entertainment aspects of these games, there is a need to change and/or increase the rules and characteristics of these games.

### SUMMARY

The disclosure is directed to a system and method for providing use for locking a game state and a preview of the game's result displayed for players of an amusement or entertainment electronic game once the game has completed its gameplay mechanic but prior to the game's end. The disclosure also provides a game structure having different game credit plays. There can be a fixed or variable number of game credit plays. A variable number of game credit plays are controlled by an action taken by a player during the game play. The electronic game service provider supplies or loads games according to the games selected.

In one aspect of the disclosure, an electronic gaming method with a preview of the game's result is provided to a player. A game field is constructed having a plurality of elements on a game display wherein each element is filled by a game symbol from a plurality of available game symbols. The game symbols for each element are automatically determined by the game ledger. Prior to the game being played, the field of game symbols is presented on the game display to the player as an attraction for deciding whether or not to play the displayed game but has no effect on game once the player interacts with the game by selecting the button to play the game or the result of the game once the gameplay mechanic is complete. The preview display of the result of the game the player just interacted with (and the game is not over until the player makes an exchange and accepts the result. If the player decides to interact with the game, the player selects the button to play the game. The player's selection is received by the game software which determines a result from the game ledger, the game plays through as each combination of symbols on the field of game symbols is displayed to the player. The player is then displayed the result. This is done without any debit to any credits on the player's account. If the player accepts the results by exchanging a credit amount for the result, the game is now complete and over. A new, unrelated to the previous result game is now ready to be played.

The disclosure provides for method and apparatus to save, lock and restore game state for a player using games in a gaming environment. The game states that may be saved or locked are any and all that are enabled by the game itself. This may include award credits, game play credits, game play states in the then current game being played by the player, and any other state saved including results from a skill, semi-skill, non-skill or arcade game.

The locked position or game state in the disclosure functions to prevent the resetting a first game itself within the preview game mechanic. By the term “first” the Applicants intend to cover a prior game relative to a subsequent game. As such it could be a second game which is locked when the subsequent game is the third game etc. This is achieved by the software protocol of the game state lock, and game result preview relating to the current game.

The locked position or game state in the disclosure operates after the player interacts with the game but prior to when the result of the first (current) game is already known to the player, namely when the game state is saved or locked.

The game system and method of the disclosure provides a code, system and methodology for maintaining the game state of the preview mechanic focused on a current game itself. For the purposes of the preview of the result of the game and locking (saved state) mechanic, there is no incorporation or reliance on a meta-game or the output results of a previously played first game or games.

With the game system and method of the disclosure results are provided from a predetermined result but the pool is not fixed. The system and method has code, system and method that manage the state of all saved (locked) games for the individual. Separately, the product has code, system and method to manage game credits. And other kinds of other currency or credits (i.e. Experience Points or XP, Meta Game, Leaderboard points.) Such features are auxiliary to or part of the core workflow of the preview of the result and lock state mechanic of the present disclosure.

With the game system and method of the disclosure, each game is separate and distinct. The player does not play the first game knowing the result in advance so as just to be displayed the first or next result. If the player accepts a result, the player can play a next game. There is no connection between the first game and a subsequent next game. The player will not be displayed that next result prior to playing the first game and exchanging the credit amount for the result.

There is no preview of a result on the screen or elsewhere at the start of a current game. What the player sees prior to interacting with the game has no relationship or preview to the game's result. The final symbol display order and corresponding result is then displayed based on the game software pulling a result from the system operator's pre-determined ledger of results. If the player chooses to exchange the credit amount for the result, the game is over. A new game is available but the result is not previewed on the game display.

With the game system and method of the disclosure, the software does not select the winning combinations prior to playing the game. The player does not play the first game knowing the result of the game in advance. The player plays the first game and is then displayed a preview of the result. At this point can the player decide to accept the result (the outcome) or leave the first game. If the player accepts the result, the player can play another game or next game. There is no connection between that first game and the next game. The player will not be displayed that next result prior to playing the next game.

If the player leaves the first game without accepting the result, the game state is saved or locked in that state. There is no next game to be saved in the system and method of the disclosure. In the game, the game state is locked in perpetuity or until such time as the operator of the game selectively decides to manually unlock it (i.e. to reactivate a player), and there is no predetermined time associated with it.

The game system and method of the disclosure does not allow a game to start being played (the beginning of the gameplay mechanic) in exchange for a wager. There is no exchange of value, no risk of value, namely no consideration in order to begin the play of a game in the disclosure. A player plays the game, at the completion of its gameplay mechanic is previewed the result, and then decides to exchange the credit amount for the result (the game credit awarded to the player in a winning result). There is also no chance element as the player is fully aware of the exchange of value and makes a conscious, self-inflicting decision to do so. At this point the game ends, and the next game is made available.

With the game system and method of the disclosure, displayed game symbols are displayed on the game display to the player like a slot machine display prior to spinning. The player then decides to play the game, but the symbols and outcome from the combination of those symbols may most likely be different than the displayed game symbols the player sees prior to playing the first game. The displayed game symbols are not a preview of the final symbols or combinations used in the outcome of symbols of the first game.

In yet another aspect of the disclosure, a method, system, and program product for electronic gaming are provided that can be integrated with various types of electronic games. A game field is constructed having a plurality of elements for a game display wherein each element is filled by a game symbol from a plurality of available game symbols. The field of game symbols is presented on the game display to the player as an attraction for deciding whether to play the displayed game. If the player decides to play the displayed game, a result is displayed on the game display once the game has completed its gameplay mechanic but prior to the game's end.

In another aspect of the disclosure, a computer program product is provided for electronic gaming with a preview of the result displayed upon completion of its gameplay mechanic. The computer program product comprises a computer readable medium having computer readable code embedded therein. The computer readable medium includes: (1) program instructions that construct a field having a plurality of elements for a game display with each element being filled by a game symbol from a plurality of available game symbols, wherein the game symbols for each element are automatically; (2) program instructions that present the field of game symbols to the player as an attraction for deciding whether or not to play the displayed game but unrelated to the result; (3) program instructions to reserve on the ledger based on credit amount selection and player ID and actives game lock state (4) program instructions send results back to game client to be displayed in the UI which then determines each combination of symbols that is formed in the display and the preview of the result amount in the display.

### BRIEF DESCRIPTION OF THE DRAWINGS

These and other advantages and aspects of the disclosure will become apparent and more readily appreciated from the following detailed description of the disclosure taken in conjunction with the accompanying drawings, as follows.

FIG. 1 is a functional flow block diagram of an example system for maintaining lock game states in accordance with electronic game displays processing logic for an exemplary embodiment of the disclosure having a game result preview. Suitable software protocols implement different phases of the flow diagram.

FIG. 2 is a functionality block diagram illustrating the component software, hardware and actions, where the software resides, and the actions to be implemented by a player by input steps; the actions and reactions of an exemplary app and its display, and the actions and reactions of the software of a system server as a game is played.

FIGS. 3A to 3E illustrate exemplary game displays at different phases of the played games according to the status of the flow diagram of FIG. 1. There is a locked display and preview screen display of the current game result relative to the first locked game display, and a view of a final display after the credit is exchanged for the result and the game has ended.

FIG. 4 illustrates hardware as it would interact and run the software and systems for the preview of the result and game lock.

FIG. 5 illustrates the server components that run on virtual or physical hardware, that interacts with and runs the software and systems for the preview of the result and game lock.

### DETAILED DESCRIPTION

Persons of ordinary skill in the art will realize that the following description of the disclosure is illustrative only and not in any way limiting. Other embodiments of the disclosure will readily suggest themselves to such skilled persons having the benefit of this disclosure.

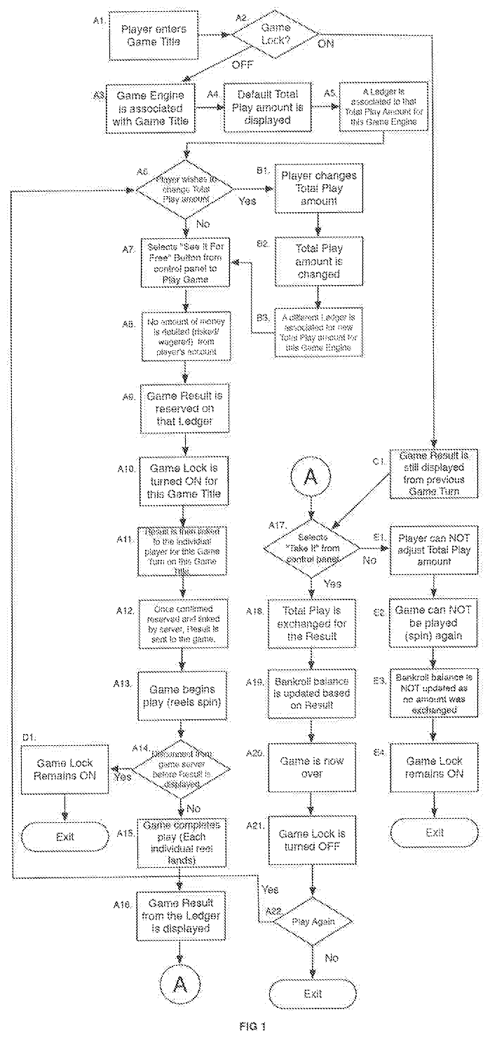

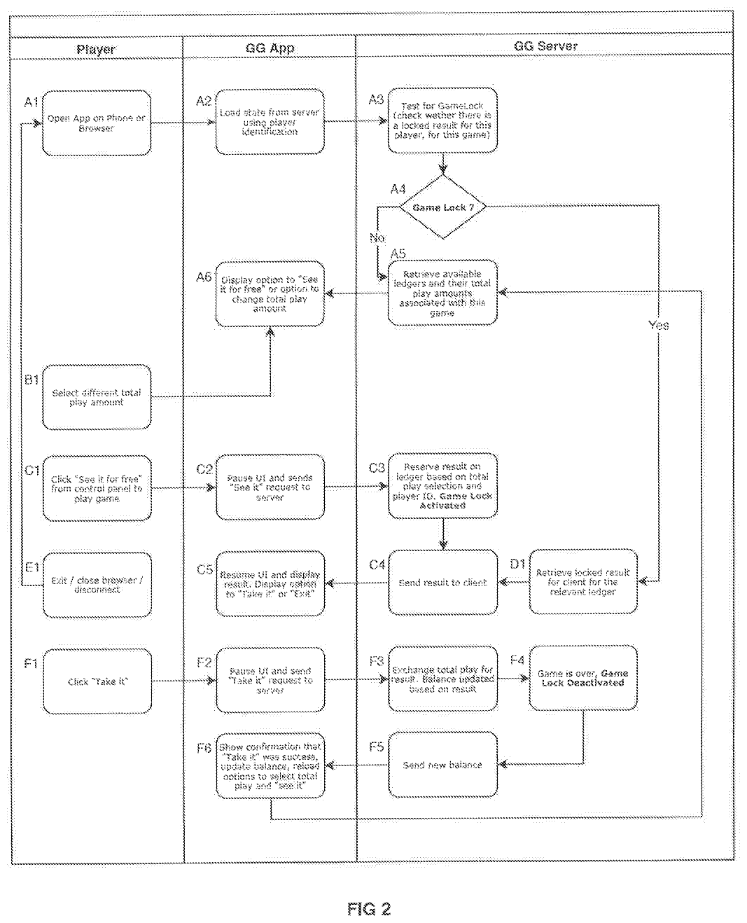

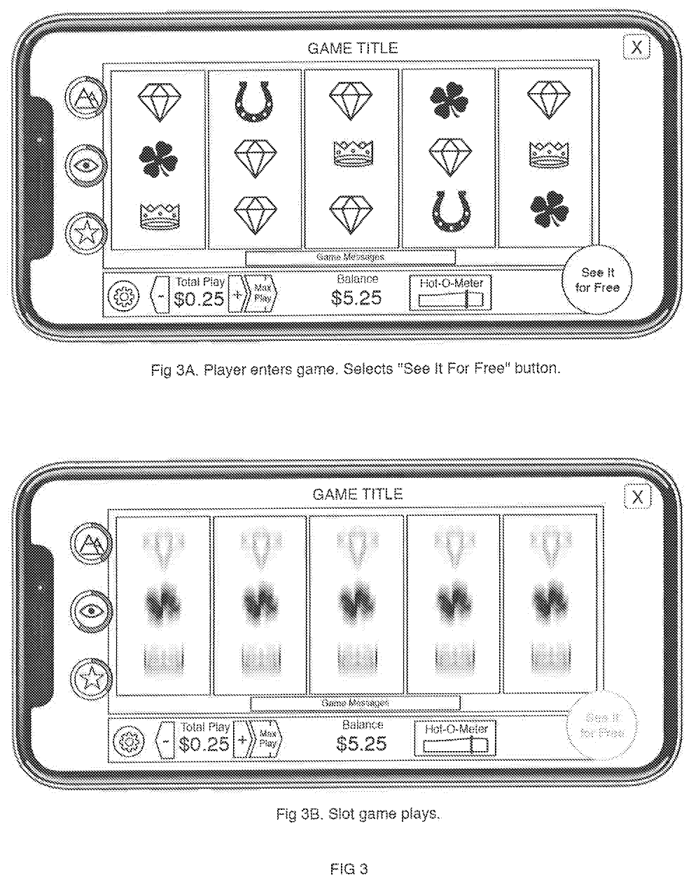

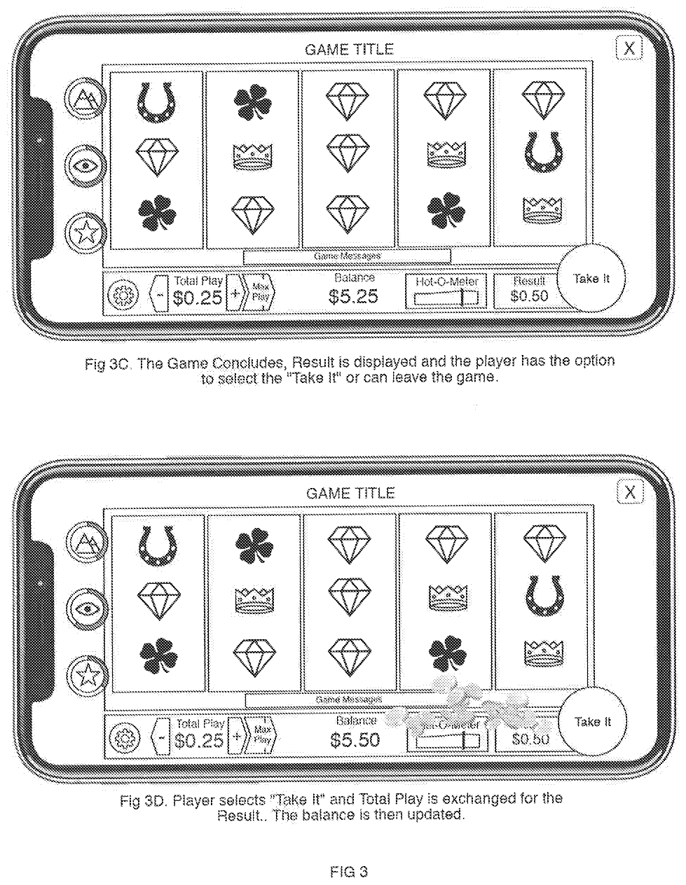

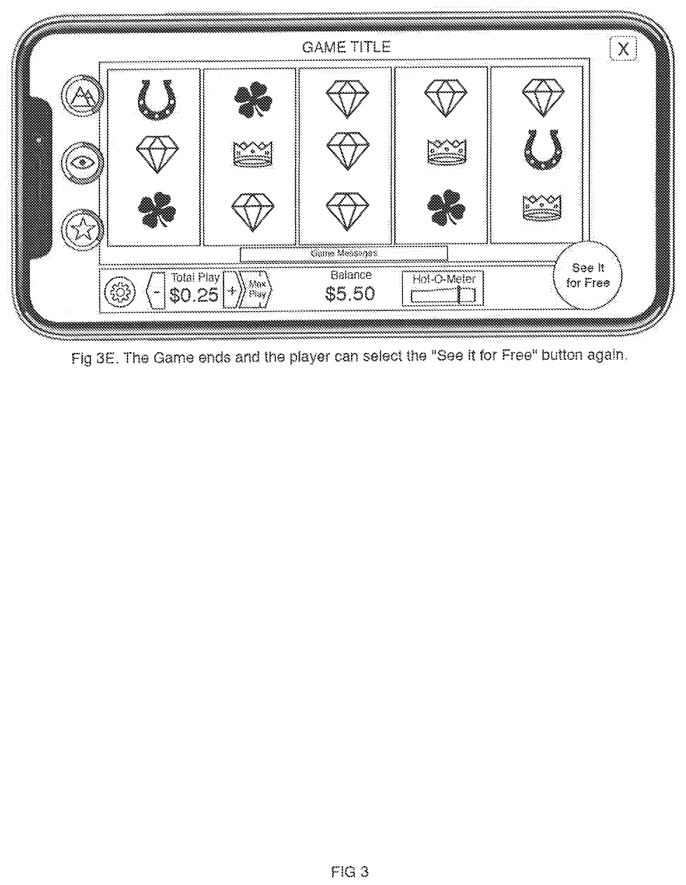

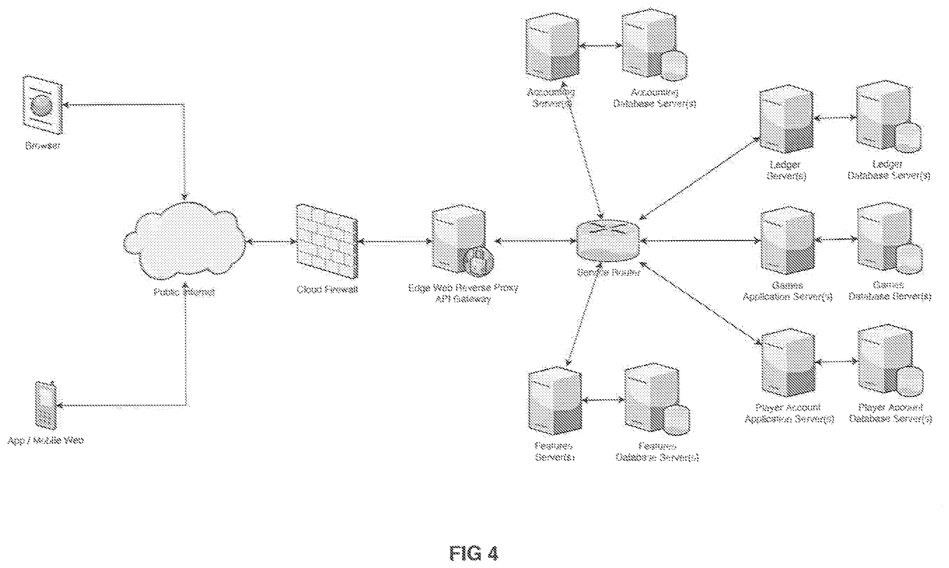

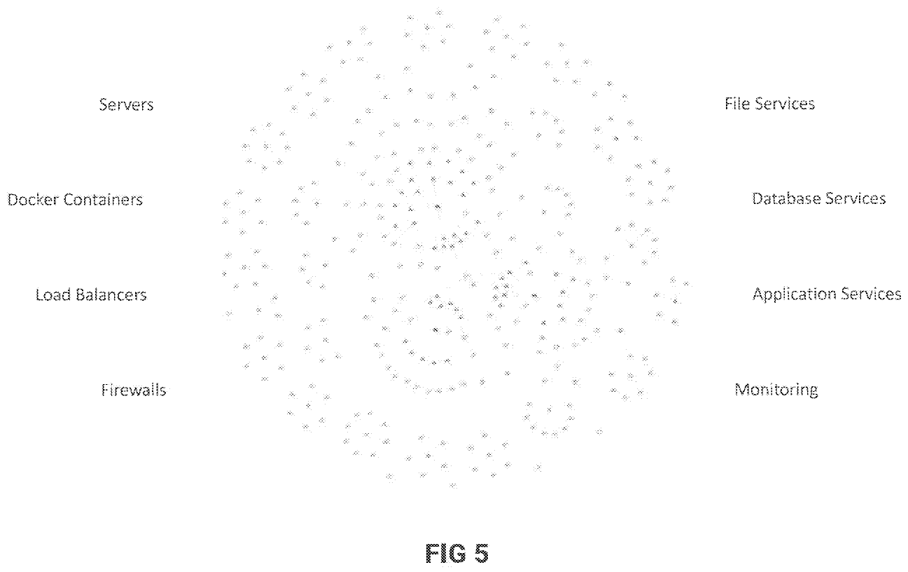

Referring to the drawings, for illustrative purposes the disclosure is shown embodied in FIG. 1, FIG. 2, FIG. 3A to 3E FIG. 4, and FIG. 5. It will be appreciated that the apparatus may vary as to configuration and as to details of the parts, and that the method may vary as to details and the order of the acts, without departing from the inventive concepts disclosed herein.

An electronic gaming method operable between a player and a system operator comprising constructing a game for a player having a plurality of elements for a game display on an electronic game device of the player.

Each element is filled by a game symbol from a plurality of predetermined game symbols, configuring the game to allow a player to play at least one first game and preview the result. The result of the game is provided selectively by a game ledger operated by the system operator and subsequently displayed to the player. Following the display result, the player optionally can exchange a credit amount for the result. There is provided a lockable game state for the first game, the lock being activated by the system operator and being dependent on the stage of play of the first game. The system operator referred to in this disclosure is the overall system server and control platform and those components which do not include the player and the player's actions. The game state system operator renders a next game available to play, selectively only, after the end of the first game.

The game symbols on the game display are displayed for the player. The symbols and result of the first game are from a predetermined ledger that provides the combination of those symbols. The combination is a result different than the displayed game symbols the player sees prior to playing. The previously displayed game symbols are not a preview of the final symbols or combinations in the result of the first game.

Data corresponding to the first state is provided. This includes at least one input device operably disposed with the game device and configured to communicate game state data of the first game between the system operator and the game device. There is at least one output device configured to produce game state data output based on the game state data in a form for communication with the player and readable by the input device.

The electronic gaming is configured to allow the player to have access to play the next game upon the occurrence and acceptance by the player of a pre-defined event in the first game. A game state manager is operably disposed within the game device and in communication with the ledger. The game state comprises data corresponding to the game's state when the game state data is received. An input device is in operable communication with the game state system operator. The game state system operator is configured to receive game state data from the input device. An output device is in operable communication with the game state system operator. The game state system operator is configured to output game state data to the output device.

A network interface device is configured to operably send and receive game state data. The input device is further configured to receive a player ID and the game state system operator is further configured to retrieve any game state data from a database over the network and game state data is correlated with the player ID.

Maintaining game state of a game device receives a game state of at least one first current game. The first current game state is lockable by a game state system operator, and the game state system operator renders a next game available for play and preview of the result after completion of the first current game. The next game is configured to have a settable lockable game state, selectively as in the first game.

In some formats or implementations of the disclosure the game state can be related to a solely non-wagering game.

The locked game state functions to prevent the resetting of the game itself within the preview of the current game result mechanic including a software protocol of the game state lock, and game result preview relating to the first game. The locked game state operates at least when the result of the current game is already known to the player or prior to the result being known if there is disconnect from the game. The locked game state includes the step of maintaining the game state such that the preview mechanic is directed on the current game.

The result is provided from a predetermined results pool, selectively not a fixed pool.

The first and next games are separate and distinct, and the player does not play the first game knowing the result in advance, and if the player accepts the result, the player is permitted to play the next game, and the next game is not displayed prior to playing or during play of the first game.

There is no preview of a result prior to interacting with the game, and a result is based on game software pulling a selected result from a pre-determined ledger of results.

The software protocol requires that in the event of a player leaving the first game without accepting the result, the game state is saved and locked in that state, and wherein a next game is not offered, and selectively the game state lock remains until the system operator unlocks the state or the player decides to accept the result by exchanging a credit amount for the result.

There is a computer program product for displaying a plurality of electronic game fields for selectively a first game for selection by a player when executed on a processor. The computer program product comprising a computer readable storage medium having computer readable code.

The computer readable storage medium comprises program instructions that receive a signal from a player to generate an electronic game of a game device, program instructions that generate a game field having a plurality of elements for the game display wherein each element includes a game symbol from a plurality of predetermined game symbols. The program instructions determine each play of the game; program instructions that display a game to be played on the game display to a player. The program instructions that receive a signal from the player generate another of the plurality of different game fields and generate and display another of the plurality of game fields.

The program instructions receive the player's selection to play prior to initiating activation of a first game play; and the program instructions can lock a game state of the first played game, solely by and delivered by a system operator. These are playable by selection of the player after the locking by the system operator of the game state of the first game and solely after the completion of the first game.

The computer program is comprised of program instructions that generate and display the next game field on the game display once the first game has ended. The program instructions prevent the resetting the game itself once the result preview of this next game is displayed, and program instructions wherein the locked game state operates when the result of the game is already known to the player.

The result preview and game lock state of the disclosure can be used in various additional embodiments. These additional embodiments can be implemented without the use of a wild symbol. Like many previous slot games, a wild symbol may be part of the game itself to represent any symbol in making a potentially winning combination but the result preview and game lock state are not reliant upon the Wild symbol in order for the mechanic to function. In the context of the electronic game having an array of symbols as described herein, the game screen can be constructed and displayed without the need for a player to do anything other than to select the button to start the game. The player would play the displayed game and then know the result prior to deciding if they want exchange a credit amount for the result.

In order to get to the next game, the player would have to play the currently previewed game result and exchange a credit amount for the result. An example of such a game display is depicted in FIGS. 3a 3b 3c in which FIG. 3a the current game is displayed prior to the player interacting with the game in which the result is not previewed and then FIG. 3b the current game in which the player has concluded and the result is now displayed but not accepted and then FIG. 3c the current game where the result is accepted and the game has ended. The exact location of the game result preview is not important.

The functionality of the work flow of FIG. 1 is described:
A1. Player enters Game Title
A2. Game Lock
   a. Off (go to A3.)
   b. On (go to C1.)
A3. Game Engine is associated with Game Title
A4. Default credit amount is displayed
A5. A Ledger is associated to that credit amount for this Game Engine
A6. Player wishes to change credit amount
   a. Yes (go to B1.)
   b. No (go to A7.)
A7. Selects “See It For Free” Button from control panel to Play Game
A8. No amount of money is debited (risked/wagered) from player's account
A9. Game Result is reserved on that Ledger
A10. Game Lock is turned ON for this Game Title
A11. Result is then linked to the individual player for this Game Turn on this Game Title
A12. Once confirmed reserved and linked by server, Result is sent to the game.
A13. Game begins play (reels spin)
A14. Disconnect from game server before Result is displayed
   a. Yes (go to D1.)
   b. No (go to A15.)
A15. Game completes play (Each individual reel lands)
A16. Game Result from the Ledger is displayed
A17. Selects “Take It” from control panel
   a. Yes (go to A18.)
   b. No (EXIT)
A18. Credit amount is exchanged for the Result A19. Bankroll balance is updated based on Result A20. Game is now over
A21. Game Lock is turned OFF
A22. Play Again
   a. Yes (go to A6.)
   b. No (EXIT)
B1. Player changes credit amount
B2. Credit amount is changed
B3. A different Ledger is associated for new credit amount for this Game Engine
   a. Go To A7.
C1. Game Result is still displayed from previous Game Turn
   a. Go To A17.
D1. Game Lock Remains ON
   a. EXIT
E1. Player can NOT adjust credit amount
E2. Game can NOT be played (spin) again
E3. Bankroll balance is NOT updated as no amount was exchanged E4. Game Lock remains ON
   a. EXIT

The functionality of the Game Lock Sequence Diagram of FIG. 2 is described:
A1. Open App on Phone or Browser (Player)
A2. Load state from server using player identification (App)
A3. Test for Game Lock (check whether there is a locked result for this player, for this game) (Server)
A4. Game Lock (Server)
   a. Yes (Go to D1)
   b. No (Go to A5)
A5. Retrieve available ledgers and their credit amounts associated with this game (Server)
A6. Display option to “See it for free” or option to change credit amount (App)
B1. Select different credit amount (Player)
   a. Yes (Go to A6)
C1. Click “See it for free” from control panel to play game (Player)
C2. Pause UI and sends “See it” request to server (App)
C3. Reserve result on ledger based on credit amount selection and player ID. Game Lock Activated (Server)
C4. Send result to client (Server)
C5. Resume UI and display result. Display option to “Take it” or “Exit”(App)
D1. Retrieve locked result for client for the relevant ledger (Server)
   a. Got To C4
E1. Exit/close browser/disconnect (Player)
   a. Go To A1
F1. Click “Take it” (Player)
F2. Pause UI and send “Take it” request to server(App)
F3. Exchange credit amount for result. Balance updated based on result (Server) F4. Game is over, Game Lock Deactivated (Server)
F5. Send new balance (Server)
F6. Show confirmation that “Take it” was success, update balance, reload options to select credit amount and “see it” (App)
   a. Go To A5

The different displays of FIGS. 3A to 3E are presentations of the game on a screen of a phone. Different inputs and outputs are shown and can be activated on a touch screen. The electronic game could be implemented online or in a physical location as a gambling or non-gambling style of gaming. The electronic game could be implemented in a kiosk or cabinet type of structure located on a casino floor or in a designated public area dedicated to game kiosk machines. The electronic game may be connected to a pre-existing or third party network or system, or be networked together with other electronic game machines of this nature or not.

A game screen may display a set of symbols, these symbols may or may not be in a winning combination but this has no effect the play of the game itself nor the resulting outcome. It is a preview of potential game pieces. The player then hits the play button to interact with the game. At this point, the ledger reserves a predetermined result and the game state lock is turned on. The game itself plays and once concluded, the result is displayed to the player. The player can then decide if they will voluntarily exchange an amount for the result. If they choose to play make the exchange, the game is over and game state lock is turned off. The player can then choose to play another game.

The preview display could also be implemented in other forms of electronic or electromechanical games. For example, it could be used in the context of an electronic or electromechanical slot machine having a plurality of spinning reels (actual or simulated) and displaying one or more lines of symbols. This could be use in the context of a video poker game, roulette or keno as an example but not limited to casino style games. The displayed game could actually be a result which may or may not be a winning combination of symbols but this has no effect on the play of the game itself nor the resulting outcome. The player would play the displayed game, then be displayed the preview of the result at which time the player can decide to accept the result and exchange a credit amount for the result. The preview screen could also be implemented in an electronic game having a plurality of reels, each reel having a plurality of symbols.

Depending on the specific game, the field can be constructed in various ways that are known to those skilled in the art. The field is then displayed to the player on the game display. The game displayed may contain a winning combination on a single or multiple lines depending on the type of game, or it may not display any winning combinations. The player can observe the displayed game for any length of time before deciding whether or not to play the displayed game, but this will not affect the play of the game itself nor the resulting outcome. The player will choose to play the game in order to see the previewed result and then decide if the player desires to exchange a credit amount for the result and thus end the game

The disclosure of an electronic game in its various embodiments has been described as a combination of hardware and software components. It is important to note, however, that those skilled in the art will appreciate that the software of the disclosure is capable of being distributed as a program product in a variety of forms, and that the disclosure applies regardless of the particular type of signal bearing media utilized to carry out the distribution. Examples of signal bearing media include, without limitation, recordable-type media such as diskettes or CD ROMs, and transmission type media such as analog or digital communications links.

In FIG. 4 the hardware as it would interact and run the software and systems for the preview of the result and game lock is shown. This includes the interactions between the software application running on devices through the public internet with servers behind a closed firewall.

In FIG. 5 the server components that run on virtual or physical hardware, that interacts with and runs the software and systems for the preview of the result and game lock are shown. These include, but is not limited to, servers, docker containers, load balancers, firewalls, messaging servers, web servers, file services, database services, application services and monitoring. The server components interact with each other in a controlled environment over networking interfaces. The server that generates the results will interact with the server that serves the results after verifying the identity and balance of the player with the servers that control access and financial records accordingly. These services may be combined to run on a single physical hardware server, or to run on many physical servers depending on the load of usage or virtual servers or combination of these

The corresponding structures, materials, acts, and equivalents of all means plus function elements in any claims below are intended to include any structure, material, or acts for performing the function in combination with other claim elements as specifically claimed.

Those skilled in the art will appreciate that many modifications to the exemplary embodiment are possible without departing from the spirit and scope of the disclosure. In addition, it is possible to use some of the features of the disclosure without the corresponding use of the other features. Other embodiments are possible. For instance in a different alternative of the system and game, the game ledger can be replaced or augmented with a random number generator or different type of server or software method to generate results. Accordingly, the foregoing description of the exemplary embodiment is provided for the purpose of illustrating the principles of the disclosure and not in limitation thereof since the scope of the disclosure is defined solely by the appended claims.

What is claimed is:

1. An electronic gaming method operable between a player and a system operator comprising constructing a game for a player having a plurality of elements for a game display on an electronic game device of the player wherein each element is filled by a game symbol from a plurality of predetermined game symbols, configuring the game to allow a player to play at least one first game where the result of the game is provided, selectively by a game ledger operated by the system operator, and the result is subsequently displayed to the player once the game itself has completed its gameplay mechanic , the player can then optionally exchange a credit amount for the result which ends the game, and providing a lockable game state for the first game, the lock being activated by the system operator and being dependent on the stage of play of the first game, and wherein the game state system operator renders a next game available to play, and if played, then displays the preview of the result and may enter into a lockable state.

2. The electronic gaming method of claim 1 comprising displaying game symbols on the game display for the player, the symbols and result of the first game are from a predetermined ledger that provides the combination of those symbols, the combination being a result different than the displayed game symbols the player sees prior to playing, and wherein the previously displayed game symbols are not a preview of the final symbols or combinations in the result of the first game.

3. The electronic gaming method of claim 1 comprising providing data corresponding to the first state; and including at least one input device operably disposed with the game device and configured to communicate game state data of the first game between the system operator and the game device; at least one output device configured to produce game state data output based on the game state data in a form for communication with the player and readable by the input device.

4. The electronic gaming method of claim 1 configured to allow the player to have access to play the next game upon the occurrence and acceptance by the player of a pre-defined event in the first game, comprising: a game state manager operably disposed within the game device and in communication with the ledger, wherein the game state comprises data corresponding to the game's state when the game state data is received and an input device in operable communication with the game state system operator, the game state system operator being configured to receive game state data from the input device; and an output device in operable communication with the game state system operator, the game state system operator configured to output game state data to the output device.

5. The game device of claim 1 further comprising a network interface device configured to operably send and receive game state data, and wherein an input device is further configured to receive a player ID and the game state system operator is further configured to retrieve any game state data from a database over the network and game state data is correlated with the player ID.

6. A method for maintaining game state of a game device, the game device being for a game and being for receiving at least one first current game, the first current game state being lockable by a game state system operator, and wherein the game state system operator renders a next game available to play and then preview the result after completion of the first current game, the next game being configured to have a settable lockable game state, selectively as in the first game.

7. A method of using savable game state by a player in a game device, the game device being in communication with a system operator, the game state being related to a game, having at least one game result preview by a player after completion of the gameplay mechanic of a first game, and configuring the game device to accept input and issue output in accordance with a game state, providing a lockable game state for the first game; providing a availability of a next game on completion of the first game, the next game being provided solely according to the discretion of the system operator, accepting input containing game state data provided by the player; the system operator processing the game state in accordance with the game device and input from the player; and, system operator issuing output in accordance with the processing to the game device and the player.

8. The electronic gaming method of claim 1 wherein the locked game state functions to prevent the resetting the game itself within the preview of the current game result mechanic including a software protocol of the game state lock, and game result preview relating to the first game.

9. The electronic gaming method of claim 1 wherein the locked game state operates at least when the result of the current game is already known to the player or prior to the result being known if there is disconnect from the game.

10. The electronic gaming method of claim 1 wherein the locked game state includes the step of maintaining the game state such that the result preview mechanic is directed on the current game.

11. The electronic gaming method of claim 1 wherein the result is provided from a predetermined results pool, selectively not a fixed pool.

12. The electronic gaming method of claim 1 wherein the first and next games are separate and distinct, and wherein the player does not play the first game knowing the result in advance, and wherein if the player accepts the result, the player is permitted to play the next game, and wherein the next game is not displayed prior to playing or during play of the first game.

13. The electronic gaming method of claim 1 wherein there is a preview of a result, and a result is based on game software pulling a selected result from a pre-determined ledger of results.

14. The electronic gaming method of claim 1 wherein the software protocol requires that in the event of a player leaving the first game without accepting the result, the game state is saved and locked in that state, and wherein a next game is not offered, and selectively the game state lock remains until the system operator unlocks the state or the player decides to accept the result by exchanging the credit amount for the result.

15. The electronic gaming method of claim 1 where the game is solely a non-wagering game.

16. The electronic gaming method of claim 1 where the game includes a non-wagering game.

17. A computer program product for displaying a plurality of electronic game fields for a first game for selection by a player when executed on a processor, the computer program product comprising a computer readable storage medium having computer readable code, the computer readable storage medium comprising: program instructions that receive a signal from a player to generate an electronic game of a game device, program instructions that generate a game field having a plurality of elements for the game display wherein each element includes a game symbol from a plurality of predetermined game symbols; program instructions that determining each play of the game; program instructions that display a game to be played on the game display to a player; program instructions that receive a signal from the player to generate another of the plurality of different game fields; program instructions that generate and display another of the plurality of game fields; program instructions that receive the player's selection of the game field to play prior to initiating activation of a first game play; program instructions to lock a game state of the first played game, solely by and delivered by a system operator and playable by selection of the player after the locking by the system operator of the game state of the first game and solely after the completion of the first game.

18. The computer program product for displaying a plurality of electronic game fields of claim 17 comprising program instructions that generate and display a new game field for the next game on the game display after an action by the player.

19. The computer program product for displaying a plurality of electronic game fields of claim 17 comprising program instructions to prevent the resetting the game itself within the result preview of the current game, and program instructions wherein the locked game state operates when the result of the first game is already known to the player.

20. The electronic gaming method of claim 1 wherein the game state system operator renders a next game available to play, selectively only, after the end of the first game.
